(19) United States
(12) Patent Application Publication
(10) Pub. No.: US 2017/0265686 A1
(43) Pub. Date: Sep. 21, 2017

(54) Cooking Mat for Producing Shaped Food Items

(71) Applicants: Erica Terrell, Charlottesville, VA (US); Micah Terrell, Charlottesville, VA (US)

(72) Inventors: Erica Terrell, Charlottesville, VA (US); Micah Terrell, Charlottesville, VA (US)

(21) Appl. No.: 15/464,936

(22) Filed: Mar. 21, 2017

Related U.S. Application Data
(60) Provisional application No. 62/311,360, filed on Mar. 21, 2016.

(51) Int. Cl. A47J 43/20; A23L 5/10

(52) U.S. Cl. CPC A47J 43/20; A23L 5/10; A23V 2002/00

(57) ABSTRACT

A cooking mat comprised of a flat surface containing at least one opening having a lip along the periphery forming a desired shape or shapes enabling users to prepare food items having traditional or unique shapes with ease. The cooking mat also enables users to prepare multiple shaped food items simultaneously, thus cutting down on meal preparation time.

### FIELD OF THE INVENTION

The invention discloses a cooking mat for use in the preparation of shaped food items.

### BRIEF DESCRIPTION OF THE DRAWINGS

These and other objects, features, advantages and aspects of the present invention can be better understood with reference to the following detailed description of the preferred embodiments when read in conjunction with the appended drawing figures.

FIG. 1 is a perspective view of the cooking mat in accordance with the present invention.

FIG. 2 is a top view of the cooking mat in accordance with the present invention showing traditional shapes.

FIG. 3 is a top view of the cooking mat of the present invention showing optional shapes.

FIG. 4 is a perspective view of the cooking mat of the present invention including handles.

FIG. 5 is a perspective view of the cooking mat of the present invention including a projected surface.

### BRIEF SUMMARY OF INVENTION

The cooking mat of the present invention produces shaped food items comprising a flat surface having a first side, a second side, a continuous edge spanning a perimeter, and at least one opening within the flat surface. Each opening in the cooking mat is defined by at least one lip having a desired thickness along a periphery of said opening. A fluid or moldable uncooked food item is placed within the opening or openings of the cooking mat where as it cooks, it spreads and forms to the shape formed by the periphery of the opening. The cooking mat of the present invention can also include at least one handle for ease of moving or flipping the cooking mat and releasing the food items. Further, the flat surface of the cooking mat can include a projected surface that extends beyond the periphery of the lip and into the opening of the cooking mat, thus providing support for the food items.

The disclosed cooking mat enables users to easily prepare shaped food items on a baking sheet, griddle, or other flat cooking surface. The cooking mat enables a cook to prepare multiple shaped food items, such as pancakes, simultaneously, thus speeding up and simplifying the preparation process. Additionally, the cooking mat enables a cook to prepare both traditionally shaped and uniquely shaped food items with ease.

### DETAILED DESCRIPTION OF THE INVENTION

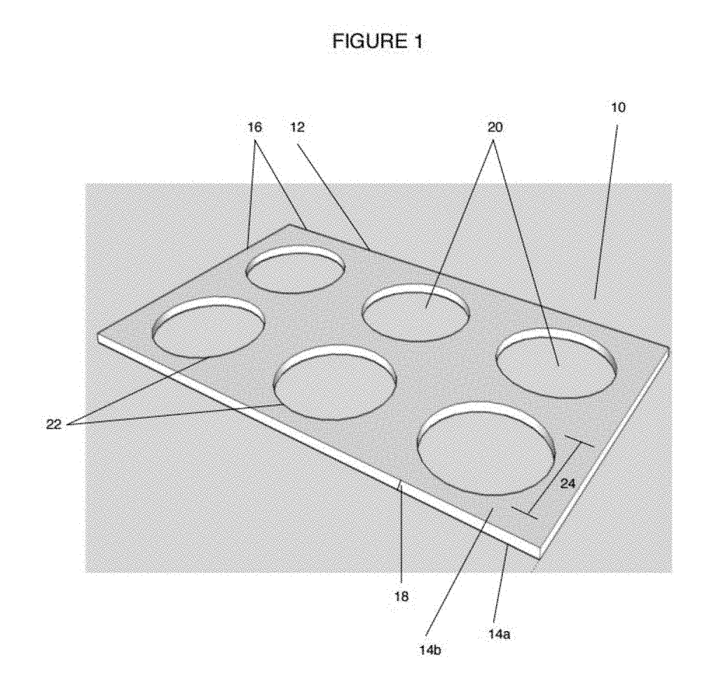

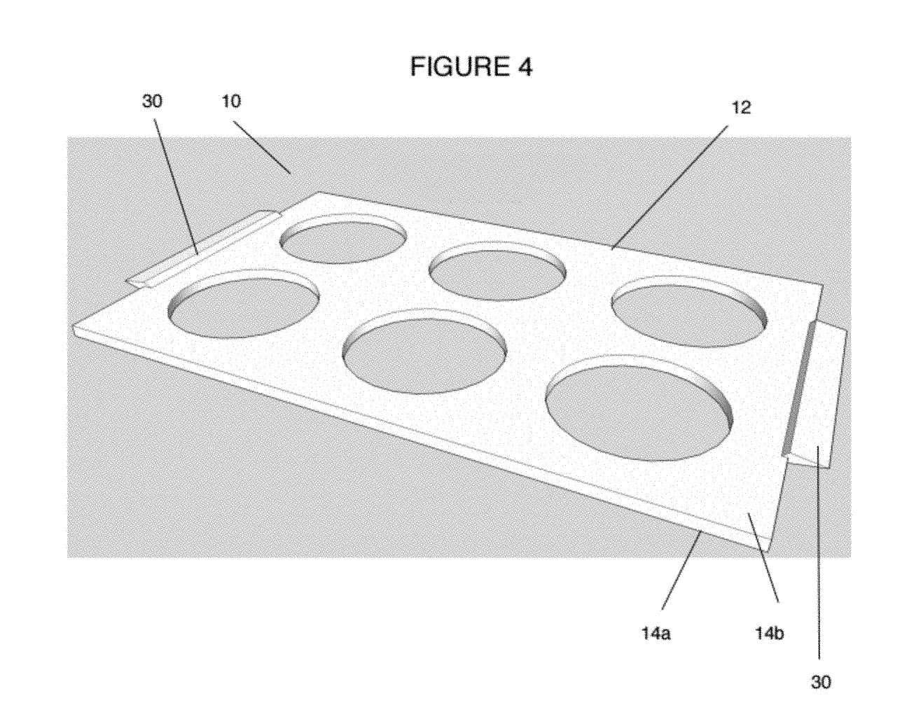

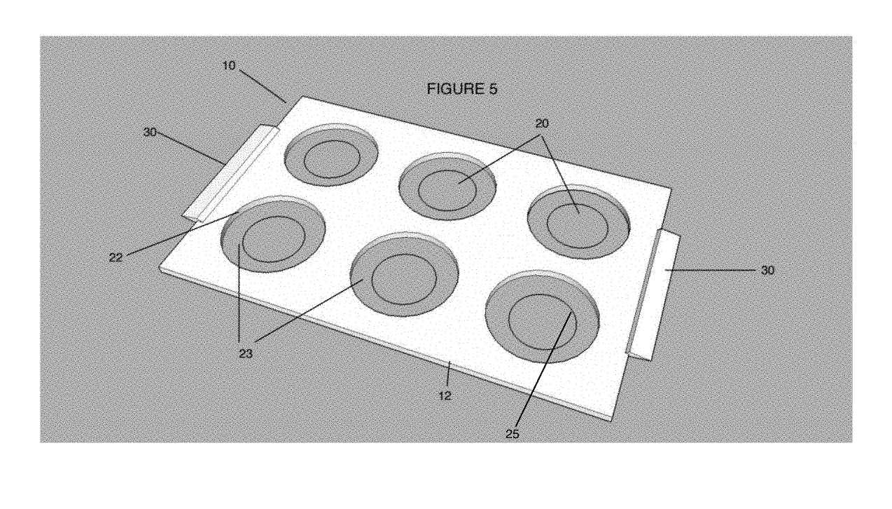

As shown in FIG. 1, the cooking mat 10 of the present invention is comprised of a flat surface 12 having at least one opening 20 within said flat surface 12. Flat surface 12, having a thickness 18, includes a first side 14a, a second side 14b, and a continuous edge 16. Each of said at least one opening 20 extends from the first side 14a to the second side 14b of the flat surface 12 and is contained within the perimeter formed by the continuous edge 16 forming the perimeter of flat surface 12. Further, each of said at least one opening 20 is comprised of a lip 22 along the periphery of each opening 20 forming desired shape 24. Lip 22 is preferably within the same plane as flat surface 12 as shown in FIG. 1. However, if desired, lip 22 could extend beyond second side 14b of flat surface 12 to provide additional thickness to the food without the need to increase the thickness of the flat surface 12, In one embodiment, cooking mat 10 further includes handles 30 extending from said flat surface 12 as shown in FIG. 4. Further, as shown in FIG. 5, each opening 20 can further include a projected surface 23 extending from, and in the same plane as, first side 14a of said flat surface past said lip 22, thus projecting into opening 20 and forming a second lip 25 rising from said first side 14a. It is preferable that second lip 25 have a minimal thickness of less than about 0.2 inch so as not to impact the appearance or cooking quality of the food item. Projected surface 23 provides support to the food item in this configuration. Projected surface 23 preferably extends at least about 0.25 inch to about 1.0 inch beyond lip 22 into opening 20, and most preferably extends 0.5 inch beyond lip 22 into opening 20.

In one embodiment, at least one opening 20 is six openings, though any number of openings reasonable to one skilled in the art and based on cooking area sizing is a possible configuration of the present invention. The diameter of each of said openings varies depending upon the dimensions of the mat and the number of openings within the mat of a particular embodiment. In an example embodiment having a mat of about 9 inches×13 inches in dimension with six openings, the diameter of each opening can be about 3.5 inches. In another embodiment having a mat of about 11 inches×15 inches in dimension with six openings, the diameter of each opening can be about 4.25 inches. It is apparent to those skilled in the art that other sized openings could be produced depending upon the desired shape and size of the food item, for instance one large opening or greater than six small openings are other possible configurations of the present invention.

Thickness 18 of flat surface 12 is critical to forming a lip 22 of opening 20 that provides a sufficient border around the periphery for creating the shape of the food item. The thickness 18 must be enough so that the substance from which the food item is being prepared, for instance pancake batter, can be contained within the opening. Preferably, thickness 18 is in the range of about 0.25 inch to about 0.75 inch, and most preferable thickness 18 is at least about 0.5 inch. The weight of mat 10 is also an important feature of the present invention in order to prevent seepage of the cooking substance from opening 20 underneath flat surface 12 thus distorting the desired shape 24 of the food item. Preferably, mat 10 weighs in the range of at least about 1 ounce to about 1 pound.

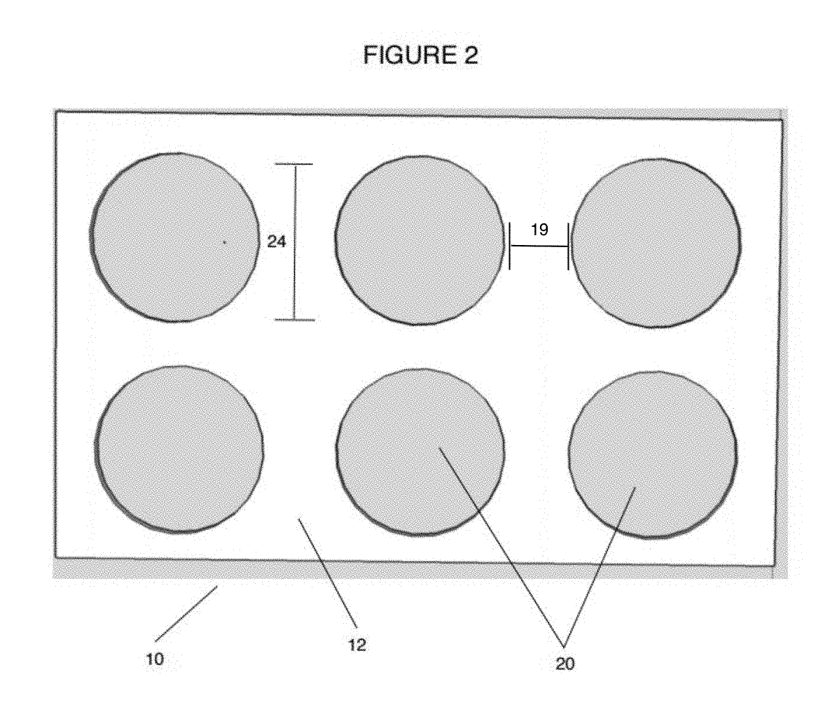

With configurations having multiple openings, each opening 20 is located within flat surface 12 so that the periphery of each opening 20 has a sufficient surface breadth 19 between the periphery of any adjacent opening 20 as shown in FIG. 2. In most applications the preferred surface breadth 19 is in the range of about 0.5 inch to about 0.75 inch. The surface breadth lends stability to the cooking mat 10 and allows for optimal heating of the cooking mat and even cooking of all food items.

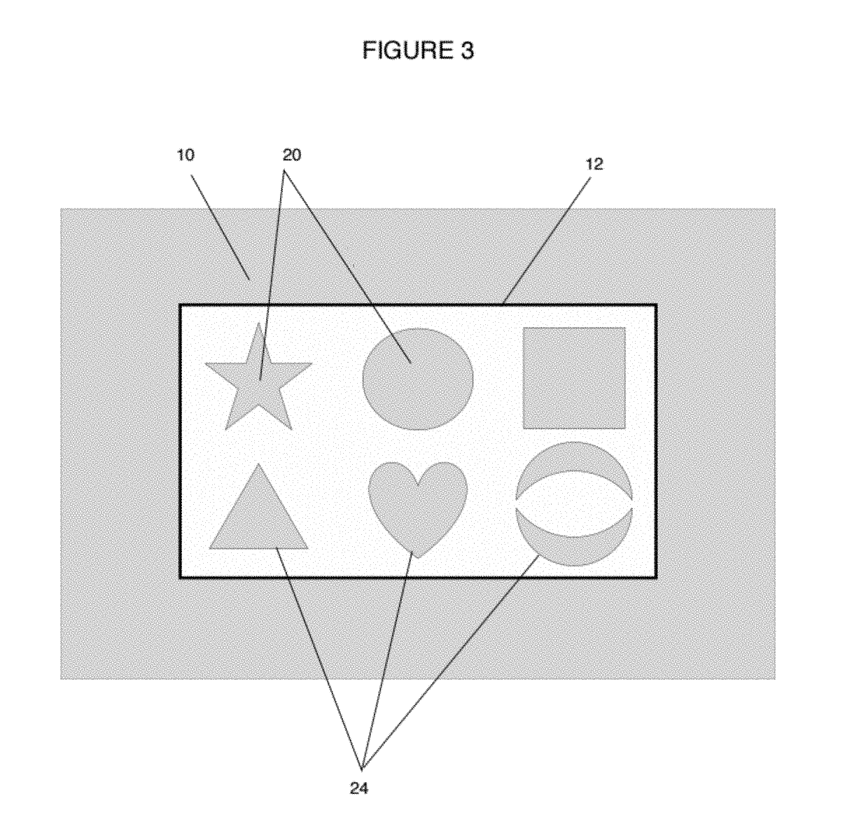

Shape 24 of at least one opening 20 of the present invention is only limited by imagination and production constraints. The most common shape 24 is a circle as shown in FIG. 1, which is the traditional shape of pancakes and other baked goods. However, as shown in FIG. 3, shape 24 can include a variety of geometric and organic shapes including but not limited to rectangles, squares, triangles, polygons, stars, flowers, hearts, crowns, animals, letters, etc. One mat 10 could contain multiple openings of a singular shape as shown in FIG. 2, or a one mat could contain multiple openings having various shapes as shown in FIG. 3. It is apparent to one skilled in the art that a wide variety of shapes are possible configurations of the present invention.

It is apparent to those skilled in the art that several materials would be appropriate for the cooking mat of the present invention as long as the material is food grade and highly heat resistant. The most preferred material of the present invention, however, is food-grade silicone which allows for heat-resistance, desirable weight, ease of production, and flexibility in use.

Traditionally, shaped food items such as pancakes are cooked on a flat cooking surface on a stove top, ideally on a griddle, skillet, or large pan on a stove top to yield a greater number of food items at once. The mat 10 of the present invention can be used in this traditional sense by placing the mat on a hot, properly greased cooking surface, with first side 14a of flat surface 12 touching the cooking surface and second side 14b facing away from the cook surface. In stove top use, an appropriate amount of the food substance, e.g. pancake batter, is dispensed within at least one opening 20 such that the food substance spreads to engage but not escape the lip along the periphery of the opening. Once the food substance is set by the cooking process, the mat 10 is removed from the cooking surface, thus leaving food items of desired shapes on the cooking surface. Removal of the mat 10 can be made easier by incorporation of at least one handle 30 on the second side 14b of flat surface 12 as shown in FIG. 4. The food items on the griddle can then be flipped with a cooking utensil to finish the cooking process. Alternately, in the embodiment having at least one handle 30 and projected surface 23 as shown in FIG. 5, the mat 10 can be picked up from the cooking surface, with projected surface 23 providing support to the food items and thus lifting the food items. Once picked up, the food items can be flipped over thus allowing the cooking process to complete with second side 14b in contact with the cooking surface.

17. While stove top use is one possibility of the present invention, another use is to bake the food item in the oven. In oven use, mat 10 of the present invention is placed on a properly greased baking surface such as a baking pan, with first side 14a of flat surface 12 touching the baking surface and second side 14b facing away from the baking surface. The baking surface can be cool or preheated. Once mat 10 is in position on the baking surface, an appropriate amount of the food substance, e.g. pancake batter, is dispensed within at least one opening 20 such that the food substance spreads to engage but not escape the lip 22 along the periphery of the opening. When all openings are filled, the baking surface is placed into a properly preheated oven and baked for an appropriate amount of time until the food item is completely cooked. Once the food item is cooked, the baking surface is removed from the oven and the mat 10 is removed from the baking surface, thus leaving food items of desired shapes on the baking surface. As noted above, removal of the mat 10 can be made easier by incorporation of at least one handle 30 on the second side 14b of flat surface 12 as shown in FIG. 4. Further, as shown in FIG. 5, the handled embodiment can include projected surface 23 thus allowing the mat to be picked up, projected surface 23 providing support to the food items and thus lifting the food items. Once picked up, the food items can be removed from the baking surface while keeping the food items within the cooking mat to be flipped onto the baking surface or transferred to another surface.

While one use of the present invention is to cook pancakes as mentioned above, any food item that can be prepared from a liquid or moldable substance, such as a batter or a dough, could be cooked using the mat of the present invention. Food items that can be cooked using the present invention include, but are not limited to, pancakes, muffins, cake, brownies, cookies, and quick breads. Other food item options will be apparent to those skilled in the art.

Other variations and modifications of the present invention will be apparent to those of ordinary skill in the art, and it is intended that such variations and modifications be covered by this disclosure. Particular values and configurations discussed above can be varied, are cited to illustrate representative embodiments of the present invention and are not intended to limit the scope of the invention.

### LIST OF COMPONENTS

Number

10 mat

12 flat surface

14a first side

14b second side

16 edge

18 thickness

19 surface breadth

20 opening

22 lip

23 projected surface

24 shape

25 second lip

30 handle(s)

What is claimed is:

1. A cooking mat for producing shaped food items comprising:
a flat surface comprising a first side, a second side, and a continuous edge spanning a perimeter;
at least one opening within said flat surface, each of said at least one opening extending from said first side to said second side and defined by at least one lip having a desired thickness along a periphery of said opening;
wherein each of said at least one opening forms at least one shape.

2. The cooking mat of claim 1 wherein said perimeter has a length of about 10 to about 15 inches and a width of about 8 to about 11 inches.

3. The cooking mat of claim 1 wherein said thickness is in the range of about 0.25 inch to about 1.0 inch.

4. The cooking mat of claim 3 wherein said thickness is at least about 0.5 inch.

5. The cooking mat of claim 1 having a weight in the range of about 1 ounce to about 16 ounces.

6. The cooking mat of claim 1 wherein said at least one opening is at least six openings.

7. The cooking mat of claim 6 further comprising a surface breadth between said periphery of said at least six openings and each adjacent periphery of said at least six openings, said surface breadth being at least about 0.5 inch.

8. The cooking mat of claim 1 wherein said at least one opening has a diameter in the range of about 2 inches to about 8 inches.

9. The cooking mat of claim 2 wherein said perimeter has a length of about 13 inches and a width of about 9 inches, wherein said at least one opening is six openings, and wherein each of said at least one opening has a diameter of about 3.5 inches.

10. The cooking mat of claim 2 wherein said perimeter has a length of about 15 inches and a width of about 11 inches, wherein said at least one opening is eight openings, and wherein each of said at least one opening has a diameter of about 4.25 inches.

11. The cooking mat of claim 1 wherein said at least one shape is a geometric shape.

12. The cooking mat of claim 1 wherein said at least one shape is an organic shape.

13. The cooking mat of claim 1 further comprising at least one handle.

14. The cooking mat of claim 13 comprising at least two handles extending from said flat surface.

15. The cooking mat of claim 14 further comprising a projected surface projecting from and on the same plane as said first side of said flat surface beyond said lip and into said opening.

16. The cooking mat of claim 15 wherein said projected surface measures in the range of about 0.25 inch to about 0.75 inch from said lip into said opening.

17. The cooking mat of claim 16 wherein said projected surface measures about 0.5 inch from said lip into said opening.

18. A cooking mat for producing shaped food items comprising:
a flat surface comprising a first side, a second side, and a continuous edge spanning a perimeter;
multiple openings within said flat surface, each of said multiple openings extending from said first side to said second side and defined by at least one lip having a desired thickness along a periphery of said opening;
a projected surface projecting from and on the same plane as said first side of said flat surface beyond said lip and into said opening.
at least one handle extending from said flat surface;
wherein each of said at least one opening forms at least one shape.

19. A method of cooking shaped food items comprising the steps of:
placing a cooking mat on a hot, flat cooking surface heated by a cooking appliance, said cooking mat comprising:
a) a flat surface comprising a first side, a second side, and a continuous edge spanning a perimeter;
b) at least one opening within said flat surface, each of said at least one opening defined by a lip having a desired thickness along a periphery of said opening;
c) wherein each of said at least one opening forms at least one shape;
placing said first side of flat surface in contact with said flat cooking surface and said second side faces away from said cooking surface;
placing a desired amount of the food substance within at least one opening, wherein a first surface of said food substance is in contact with the cooking surface and a second surface of said food substance faces away from said cooking surface, and wherein the food substance spreads to engage but not escape the lip along the periphery of the opening;
allowing said food substance to set to desired level of doneness;
lifting the mat from said flat cooking surface to facilitate removal if said food items.

20. The method of claim 19 further comprising the step of lifting said cooking mat from said flat cooking surface by at least one handle extending from said flat surface of said cooking mat; and wherein said cooking mat is flipped to engage said second surface of said food substance with said cooking surface.
